(19) United States
(12) Patent Application Publication
(10) Pub. No.: US 2021/0372196 A1
(43) Pub. Date: Dec. 2, 2021

(54) INSULATING GLAZING UNIT

(71) Applicant: CORNING INCORPORATED, CORNING, NY (US)

(72) Inventors: Joon Hoi Kim, Yongin-si (KR); Sung Jun Lim, Asan-si (KR); Jin-Wook Song, Seongnam (KR)

(21) Appl. No.: 17/264,020

(22) PCT Filed: Jul. 18, 2019
(86) PCT No.: PCT/US2019/042373

§ 371 Date: Jan. 28, 2021

(30) Foreign Application Priority Data
Jul. 30, 2018 (KR) 10-2018-0088653

(51) Int. Cl. E06B 3/67; E06B 3/66; E06B 3/54; E06B 3/663; E06B 3/673

(52) U.S. Cl. CPC E06B 3/6715; E06B 3/6621; E06B 3/67326; E06B 3/66304; E06B 3/5454

(57) ABSTRACT

An insulating glazing unit is provided, including: a first glass pane and a second glass pane; an intermediate glass pane; a first spacer and a second spacer; and a holder holding together the first glass pane, the second glass pane, the intermediate glass pane, the first spacer, and the second spacer. In the insulating glazing unit, a thickness of the intermediate glass pane is less than the first glass pane and the second glass pane, too and a composition of the intermediate glass pane is different from the first glass pane the second glass pane.

### BACKGROUND

### CROSS-REFERENCE TO RELATED PATENT APPLICATION

This application claims the benefit of Korean Patent Application No. 10-2018-0088653, filed on Jul. 30, 2018, in the Korean Intellectual Property Office, the disclosure of which is incorporated herein in its entirety by reference.

### Field

One or more embodiments relate to insulating glazing units. More particularly, one or more embodiments relate to an insulating glazing unit including a plurality of glass panes.

Description of the Related Art

Interest in insulating glazing units is increasing as regulations on energy efficiency of buildings are strengthened. Moreover, insulating glazing units have recently been being used as windows in refrigerators or freezers.

In general, insulating glazing units include a plurality of glass panes spaced apart from each other, and gas, such as air, may fill spaces between the glass panes. In general, with an increase in the number of glass panes included in an insulating glazing unit, heat-insulation performance of the insulating glazing unit may improve, but its weight may increase.

### SUMMARY

One or more embodiments include an insulating glazing unit that is lightweight and transparent and has a low risk of thermal breakage due to a temperature difference.

Additional aspects will be set forth in part in the description which follows and, in part, will be apparent from the description, or may be learned by practice of the presented embodiments.

According to one or more embodiments, an insulating glazing unit includes a first glass pane and a second glass pane apart from each other and arranged in parallel to each other; an intermediate glass pane between the first glass pane and the second glass pane; a first spacer between the first glass pane and the intermediate glass pane and separating the first glass pane from the intermediate glass pane; a second spacer between the second glass pane and the intermediate glass pane and separating the second glass pane from the intermediate glass pane; and a holder covering an edge portion of the first glass pane and an edge portion of the second glass pane and holding together the first glass pane, the second glass pane, the intermediate glass pane, the first spacer, and the second spacer, wherein a thickness of the intermediate glass pane is less than a thickness of the first glass pane and a thickness of the second glass pane, and a composition of the intermediate glass pane is different from a composition of the first glass pane and a composition of the second glass pane.

The thickness of the intermediate glass pane may be about 0.2 mm to about 1.0 mm.

A coefficient of thermal expansion of the intermediate glass pane may be less than a coefficient of thermal expansion of the first glass pane and a coefficient of thermal expansion of the second glass pane.

The intermediate glass pane may not have undergone a strengthening process.

Solar absorptance of the intermediate glass pane may be less than solar absorptance of the first glass pane and solar absorptance of the second glass pane.

Solar transmittance of the intermediate glass pane may be greater than solar transmittance of the first glass pane and solar transmittance of the second glass pane.

A density of the intermediate glass pane may be less than a density of the first glass pane and a density of the second glass pane.

Each of the first glass pane and the second glass pane may be formed of soda-lime glass, and the intermediate glass pane may be formed of boro-aluminosilicate glass.

According to one or more embodiments, an insulating glazing unit includes a first soda-lime glass pane and a second soda-lime glass pane apart from each other and arranged in parallel to each other; a boro-aluminosilicate glass pane between the first soda-lime glass pane and the second soda-lime glass pane; a first spacer between the first soda-lime glass pane and the boro-aluminosilicate glass pane; a second spacer between the second soda-lime glass pane and the boro-aluminosilicate glass pane; and a holder covering an edge portion of the first soda-lime glass pane and an edge portion of the second soda-lime glass pane and holding together the first soda-lime glass pane, the second soda-lime glass pane, the boro-aluminosilicate glass pane, the first spacer, and the second spacer, wherein a thickness of the boro-aluminosilicate glass pane is less than a thickness of the first soda-lime glass pane and a thickness of the second soda-lime glass pane.

According to one or more embodiments, an insulating glazing unit includes a first glass plane and a second glass plane apart from each other and arranged in parallel to each other; a plurality of intermediate glass panes between the first glass pane and the second glass pane and spaced apart from each other; a plurality of spacers respectively arranged between the first glass pane and one of the plurality of intermediate glass panes, between the second glass pane and another of the plurality of intermediate glass panes, and between the plurality of intermediate glass panes; and a holder covering an edge portion of the first glass pane and an edge portion of the second glass pane and holding together the first glass pane, the second glass pane, the plurality of intermediate glass panes, and the plurality of spacers, wherein a thickness of each of the plurality of intermediate glass panes is less than a thickness of the first glass pane and a thickness of the second glass pane, and a composition of each of the plurality of intermediate glass panes is different from a composition of the first glass pane and a composition of the second glass pane.

According to one or more embodiments, a building includes the insulating glazing unit.

According to one or more embodiments, a refrigerator includes the insulating glazing unit.

According to one or more embodiments, a freezer includes the insulating glazing unit.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cut-away perspective view of an insulating glazing unit according to an embodiment of the present disclosure;

FIG. 2 is a cross-sectional view of an insulating glazing unit according to an embodiment of the present disclosure;

FIG. 3 is a plan view of an intermediate glass pane according to an embodiment of the present disclosure;

FIG. 4 is a cut-away perspective view of an insulating glazing unit according to an embodiment of the present disclosure; and

FIGS. 5A through 5F are graphs showing temperature profile simulation results of first through sixth cases when insulating glazing units corresponding to the first through sixth cases are exposed to sunlight.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

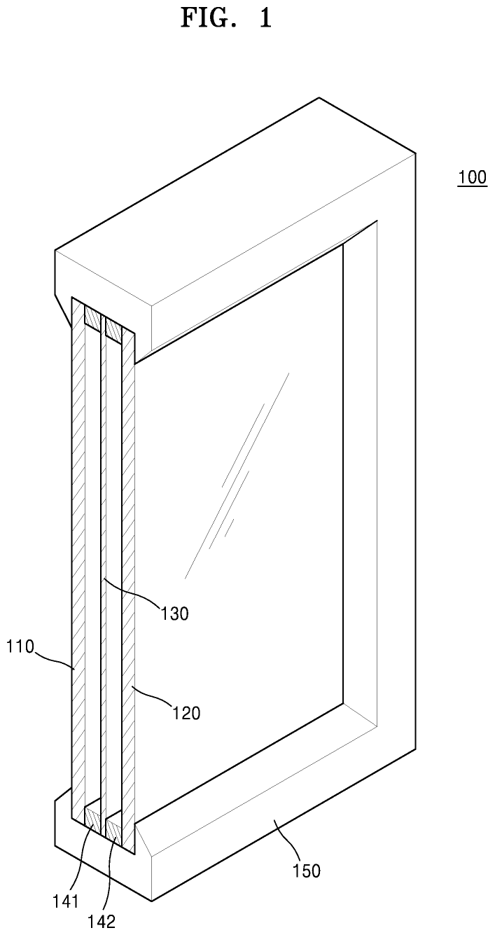

FIG. 1 is a cut-away perspective view of an insulating glazing unit 100 according to an embodiment of the present disclosure.

Referring to FIG. 1, the insulating glazing unit 100 according to an embodiment may include a first glass pane 110, a second glass pane 120, an intermediate glass pane 130, a first spacer 141, a second spacer 142, and a holder 150.

The first and second glass panes 110 and 120 are spaced from each other and arranged in parallel. The intermediate glass pane 130 is positioned between the first glass pane 110 and the second glass pane 120.

The intermediate glass pane 130 and the first glass pane 110 are spaced apart from each other by the first spacer 141. In other words, the first spacer 141 is positioned between the first glass pane 110 and the intermediate glass pane 130. In detail, the first spacer 141 is positioned between an edge portion of the first glass pane 110 and an edge portion of the intermediate glass pane 130. The first spacer 141 extends along the edge portion of the first glass pane 110.

The intermediate glass pane 130 and the second glass pane 120 are spaced apart from each other by the second spacer 142. In other words, the second spacer 142 is positioned between the second glass pane 120 and the intermediate glass pane 130. In detail, the second spacer 142 is interposed between an edge portion of the second glass pane 120 and the edge portion of the intermediate glass pane 130. The second spacer 142 extends along the edge portion of the second glass pane 120.

A space between the first glass pane 110 and the intermediate glass pane 130 and a space between the second glass pane 120 and the intermediate glass pane 130 may each be filled with air, inert gas, or a combination thereof.

The holder 150 holds the first glass pane 110, the second glass pane 120, the intermediate glass pane 130, the first spacer 141, and the second spacer 142 together. The holder 150 may cover the edge portion of the first glass pane 110 and the edge portion of the second glass pane 120. On the other hand, the holder 150 may not cover a central portion of the first glass pane 110 and a central portion of the second glass pane 120. The holder 150 may extend along edges of the first and second glass panes 110 and 120. The holder 150 may include, for example, a frame. A window, a refrigerator, a freezer, and a building may include the frame. According to some embodiments, the holder 150 may include a portion of a building, a portion of a refrigerator, or a portion of a freezer. According to some embodiments, the holder 150 may be formed of a sealing material or an adhesive material.

According to some embodiments, the first spacer 141 and the second spacer 142 may be integrally formed with the holder 150.

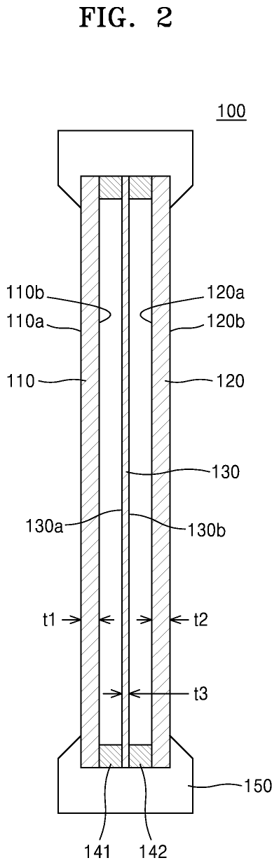

FIG. 2 is a cross-sectional view of the insulating glazing unit 100 according to an embodiment of the present disclosure.

Referring to FIG. 2, the first glass pane 110 has a first main surface 110a and a second main surface 110b that are parallel to each other and are apart from each other by a first thickness t1. The second glass pane 120 has a first main surface 120a and a second main surface 120b that are parallel to each other and are apart from each other by a second thickness t2. The intermediate glass pane 130 has a first main surface 130a and a second main surface 130b that are parallel to each other and are apart from each other by a third thickness t3. The third thickness t3 of the intermediate glass pane 130 is less than the first thickness t1 of the first glass pane 110 and the second thickness t2 of the second glass pane 120. For example, the first thickness t1 of the first glass pane 110 and the second thickness t2 of the second glass pane 120 may each be about 1 mm to about 20 mm, and the third thickness t3 of the intermediate glass pane 130 may be about 0.2 mm to about 1.0 mm.

Reduction of the third thickness t3 of the intermediate glass pane 130 is beneficial because the weight of the insulating glazing unit 100 may decrease. For example, when the third thickness t3 of the intermediate glass pane 130 is about 1/10 of the first thickness t1 of the first glass pane 110 and the second thickness t2 of the second glass pane 120, the weight of the insulating glazing unit 100 is about 30% less than that when the third thickness t3 of the intermediate glass pane 130 is equal to the first thickness t1 of the first glass pane 110 and the second thickness t2 of the second glass pane 120.

However, as the third thickness t3 of the intermediate glass pane 130 decreases, it may be difficult to handle the intermediate glass pane 130. In particular, when the third thickness t3 of the third glass pane 130 is less than or equal to about 1.0mm, a heat-strengthening process is impossible. According to an embodiment of the present disclosure, the intermediate glass pane 130 may not undergo a strengthening process such as a heat-strengthening process or a chemical-strengthening process. Accordingly, in this case, the third thickness t3 of the intermediate glass pane 130 may be less than or equal to about 1.0 mm. However, when the third thickness t3 of the intermediate glass pane 130 is less than or equal to 0.2 mm, it may be difficult to handle the intermediate glass pane 130, and thus it is also difficult to assemble the insulating glazing unit 100. Accordingly, the third thickness t3 of the intermediate glass pane 130 may be equal to or greater than about 0.2 mm.

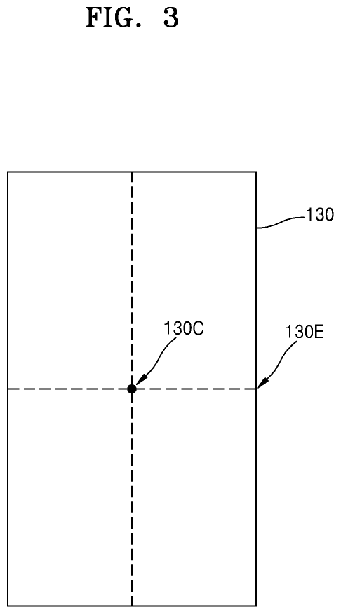

FIG. 3 is a plan view of the intermediate glass pane 130 according to an embodiment of the present disclosure.

Referring to FIGS. 2 and 3, when the insulating glazing unit 100 is exposed to sunlight, sunlight may be almost blocked on an edge location 130E in the intermediate glass pane 130 by the holder 150, but a center location 130C in the intermediate glass pane 130 may be exposed to sunlight. Accordingly, a temperature increase of the center location 130C on the intermediate glass pane 130 may be greater than that of the edge location 130E on the intermediate glass pane 130. Due to a difference between temperatures of the center location 130C and the edge location 130E on the intermediate glass pane 130, an internal stress may be generated within the intermediate glass pane 130, and the internal stress within the intermediate glass pane 130 may cause thermal breakage of the intermediate glass pane 130. When the intermediate glass pane 130 does not undergo a heat-strengthening process, the intermediate glass pane 130 may be vulnerable to this thermal breakage. In particular, when the thin intermediate glass pane 130 is formed of soda lime that is widely used as window glass, the thin intermediate glass pane 130 may be weak to this thermal breakage, and thus a heat-strengthening process is needed. Consequently, it is difficult to make the intermediate glass pane 130 have a thickness of about 1.0 mm or less.

According to an embodiment of the present disclosure, a composition of the intermediate glass pane 130 is different from that of the first glass pane 110 and that of the second glass pane 120 such that the thin intermediate glass pane 130 may withstand thermal breakage even without undergoing a heat-strengthening process. For example, each of the first glass pane 110 and the second glass pane 120 may be formed of soda-lime glass that is commonly used in windows, and the intermediate glass pane 130 may be formed of boro-aluminosilicate glass. The intermediate glass pane 130 may be, for example, Eagle XG® by Corning. In this specification, the first glass pane 110 formed of soda-lime glass may be referred to as a first soda-lime glass pane, the second glass pane 120 formed of soda-lime glass may be referred to as a second soda-lime glass pane, and the intermediate glass pane 130 formed of boro-aluminosilicate glass may be referred to as a boro-aluminosilicate glass pane. Table 1 below shows compositions of the first soda-lime glass pane 110 and the second soda-lime glass pane 120, and Table 2 below shows a composition of the boro-aluminosilicate glass pane 130.

TABLE 1

| | Composition (wt %) |
|---|---|
| SiO₂ | 72~74 |
| Na₂O | 13~14 |
| CaO | 9~11 |
| Al₂O₃ | 1.0~2.0 |
| K₂O | 0.01~0.3 |
| MgO | 0.01~4.0 |
| Fe₂O₃ | 0.01~0.2 |
| TiO₂ | 0.01~0.1 |

TABLE 2

| | Composition (wt %) |
|---|---|
| SiO₂ | 55~65 |
| Al₂O₃ | 15~20 |
| B₂O₃ | 5~15 |
| MgO | 0.1~5 |
| CaO | 1~10 |
| SrO | 0.5~8.0 |
| BaO | 0.01~0.5 |

According to some embodiments, solar absorptance of the intermediate glass pane 130 may be less than solar absorptance of the first glass pane 110 and solar absorptance of the second glass pane 120. For example, solar absorptance of the boro-aluminosilicate glass pane 130 may be about 0.1% to about 1.0%, and solar absorptance of the first soda-lime glass pane 110 and solar absorptance of the second soda-lime glass pane 120 may each be about 5.0% to about 15.0%. In this specification, a solar spectrum uses a NFRC100-2010 standard. When the solar absorptance of the intermediate glass pane 130 is small, a temperature increase of the intermediate glass pane 130 is not large when the intermediate glass pane 130 is exposed to sunlight, and accordingly the risk of thermal breakage of the intermediate glass pane 130 may be little.

Solar transmittance of the intermediate glass pane 130 may be greater than solar transmittance of the first glass pane 110 and solar transmittance of the second glass pane 120. Solar transmittance of the boro-aluminosilicate glass pane 130 may be 90% to 95%, and solar transmittance of the first soda-lime glass pane 110 and solar transmittance of the second soda-lime glass pane 120 may each be about 75% to about 85%. When the solar transmittance of the intermediate glass pane 130 is relatively high, the intermediate glass pane 130 and the insulating glazing unit 100 including the same may be relatively transparent.

According to some embodiments, a coefficient of thermal expansion (CTE) of the intermediate glass pane 130 may be less than that of the first glass pane 110 and that of the second glass pane 120. For example, a CTE of the boro-aluminosilicate glass pane 130 may be about 3×10⁻⁶/° C. to about 4×10⁻⁶/° C., and a CTE of the first soda-lime glass pane 110 and a CTE of the second soda-lime glass pane 120 may each be about 9×10⁻⁶/° C. to about 1×10⁻⁵/° C. Because a residual stress due to a temperature difference within the intermediate glass pane 130 is proportional to the CTE of the intermediate glass pane 130, when the CTE of the intermediate glass pane 130 is small, the possibility that thermal breakage of the intermediate glass pane 130 occur may be reduced.

According to some embodiments, an edge strength of the intermediate glass pane 130 may be greater than that of the first glass pane 110 and that of the second glass pane 120. For example, a 0.8% breakable edge strength of the boro-aluminosilicate glass pane 130 may be about 94.5 MPa, and those of the first and second soda-lime glass panes 110 and 120 may each be about 39 MPa. When the edge strength of the intermediate glass pane 130 is high, the possibility that thermal breakage of the intermediate glass pane 130 occurs may be reduced.

According to some embodiments, a density of the intermediate glass pane 130 may be less than that of the first glass pane 110 and that of the second glass pane 120. For example, a density of the boro-aluminosilicate glass pane 130 may be about 2.3 g/cm³ to about 2.5 g/cm³, and that of the first soda-lime glass pane 110 and that of the second soda-lime glass pane 120 may each be about 2.5 g/cm³ to about 2.6 g/cm³. When the density of the intermediate glass pane 130 is small, the weight of the intermediate glass pane 130 decreases.

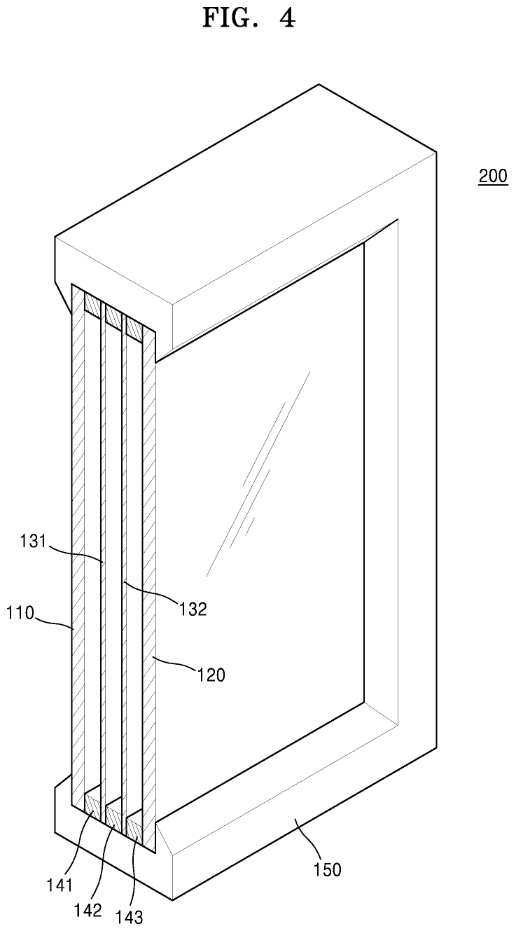

FIG. 4 is a cut-away perspective view of an insulating glazing unit 200 according to an embodiment of the present disclosure. A difference between the insulating glazing unit 200 of FIG. 4 and the insulating glazing units 100 of FIGS. 1 and 2 will now be described.

Referring to FIG. 4, the insulating glazing unit 200 according to an embodiment may include the first glass pane 110, the second glass pane 120, a plurality of intermediate glass panes, namely, first and second intermediate glass panes 131 and 132, a plurality of spacers, namely, first, second, and third spacers 141, 142, and 143, and the holder 150. Although the insulating glazing unit 200 includes the two intermediate glass panes 131 and 132 in FIG. 4, the insulating glazing unit 200 may include three or more intermediate glass panes. The insulating glazing unit 200 according to an embodiment may provide good heat-insulation performance by including the plurality of intermediate glass panes 131 and 132.

The plurality of intermediate glass panes 131 and 132 are positioned between the first glass pane 110 and the second glass pane 120. The first glass pane 110 and the first intermediate glass pane 131 are spaced apart from each other by the first spacer 141, and the first intermediate glass pane 131 and the second intermediate glass pane 132 are spaced apart from each other by the second spacer 142. The second intermediate glass pane 132 and the second glass pane 120 are spaced apart from each other by the third spacer 143. In other words, the first spacer 141 is interposed between the first glass pane 110 and the first intermediate glass pane 131. The second spacer 142 is interposed between the first intermediate glass pane 131 and the second intermediate glass pane 132. The third spacer 143 is interposed between the second intermediate glass pane 132 and the second glass pane 120.

A space between the first glass pane 110 and the first intermediate glass pane 131, a space between the first intermediate glass pane 131 and the second intermediate glass pane 132, and a space between the second intermediate glass pane 132 and the second glass pane 120 may each be filled with air, inert gas, or a combination thereof.

A thickness of each of the plurality of intermediate glass panes 131 and 132 is less than that of the first glass pane 110 and that of the second glass pane 120, and a composition of each of the plurality of intermediate glass panes 131 and 132 is different from that of the first glass pane 110 and that of the second glass pane 120.

According to another embodiment, a building including the insulating glazing unit 100 of FIG. 1 or the insulating glazing unit 200 of FIG. 4 may be provided.

According to another embodiment, a refrigerator including the insulating glazing unit 100 of FIG. 1 or the insulating glazing unit 200 of FIG. 4 may be provided.

According to another embodiment, a freezer including the insulating glazing unit 100 of FIG. 1 or the insulating glazing unit 200 of FIG. 4 may be provided.

The present disclosure will now be described in more detail by using six cases listed in Table 3 below.

TABLE 3

| | | | Glass thickness |
|---|---|---|---|
| | | Glass type | (mm) |
| First case | First glass pane | Soda lime | 5 |
| (first | Intermediate glass | Boro-aluminosilicate | 0.5 |
| embodiment) | pane | | |
| | Second glass pane | Soda lime | 5 |
| Second case | First glass pane | Soda lime | 5 |
| (first | Intermediate glass | Soda lime | 5 |
| comparative | pane | | |
| example) | Second glass pane | Soda lime | 5 |
| Third case | First glass pane | Soda lime | 5 |
| (second | Intermediate glass | Soda lime | 0.5 |
| comparative | pane | | |
| example) | Second glass pane | Soda lime | 5 |
| Fourth case | First glass pane | Soda lime | 5 |
| (second | First intermediate | Boro-aluminosilicate | 0.5 |
| embodiment) | glass pane | | |
| | Second | Boro-aluminosilicate | 0.5 |
| | intermediate glass | | |
| | pane | | |
| | Second glass pane | Soda lime | 5 |
| Fifth case | First glass pane | Soda lime | 5 |
| (third | First intermediate | Soda lime | 5 |
| comparative | glass pane | | |
| example) | Second | Soda lime | 5 |
| | intermediate glass | | |
| | pane | | |
| | Second glass pane | Soda lime | 5 |
| Sixth case | First glass pane | Soda lime | 5 |
| (fourth | First intermediate | Soda lime | 0.5 |
| comparative | glass pane | | |
| example) | Second | Soda lime | 0.5 |
| | intermediate glass | | |
| | pane | | |
| | Second glass pane | Soda lime | 5 |

Table 4 below shows a simulation result of solar transmittance and visible light transmittance of first through sixth cases.

TABLE 4

| | Solar transmittance | Visible light transmittance |
|---|---|---|
| | (%) | (%) |
| First case (first | 62.7 | 74.9 |
| embodiment) | | |
| Second case (first | 56.4 | 72.8 |
| comparative example) | | |
| Third case (second | 62.3 | 74.2 |
| comparative example) | | |
| Fourth case (second | 58.5 | 69.9 |
| embodiment) | | |
| Fifth case (third | 47.6 | 66.1 |
| comparative example) | | |
| Sixth case (fourth | 57.5 | 68.5 |
| comparative example) | | |

Referring to Table 4, the first case (first embodiment) provides higher solar transmittance and higher visible light transmittance than the second case (first comparative example) and the third case (second comparative example), and the fourth case (second embodiment) provides higher solar transmittance and higher visible light transmittance than the fifth case (third comparative example) and the sixth case (fourth comparative example). In other words, insulating glazing units according to embodiments of the present disclosure may have increased solar transmittance and increased visible light transmittance by employing, as an intermediate glass pane, a thin boro-aluminosilicate glass pane instead of a soda-lime glass pane. Accordingly, the insulating glazing units according to embodiments of the present disclosure may be more transparent than existing insulating glazing units.

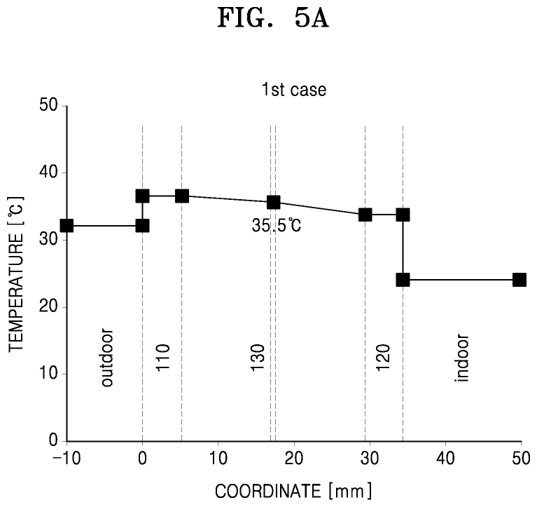

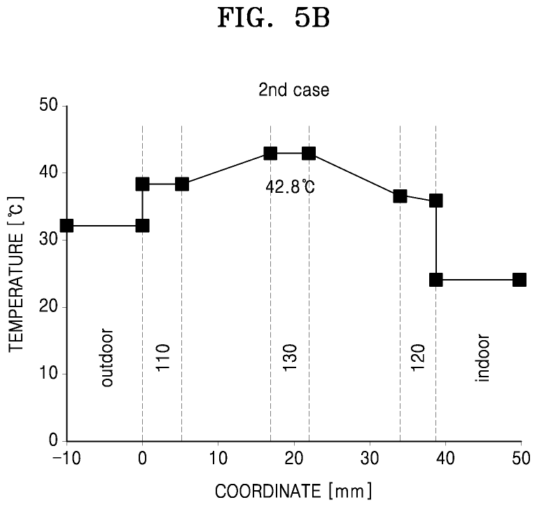

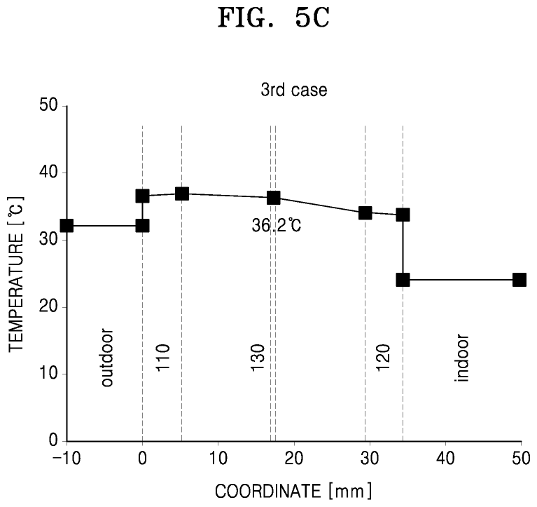

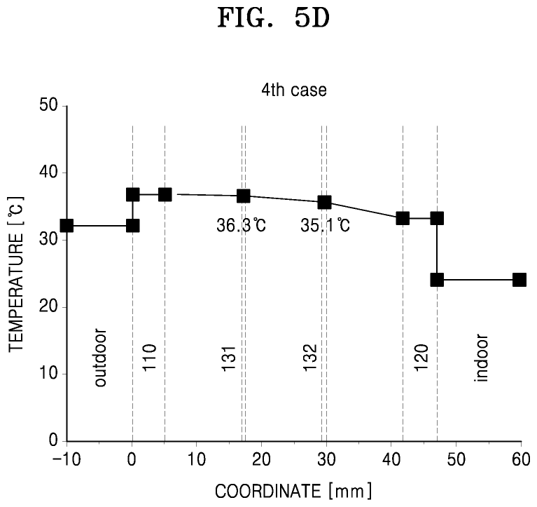

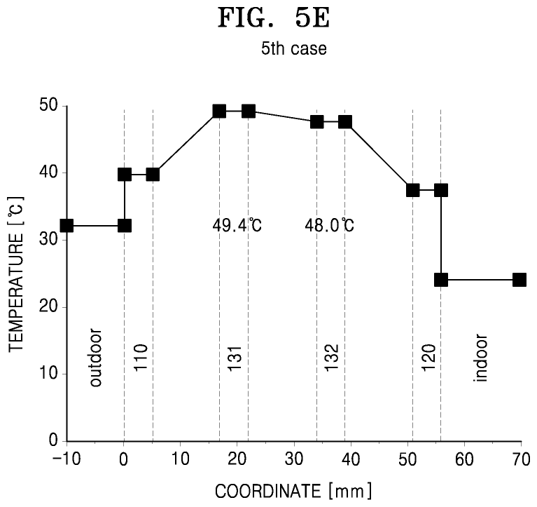

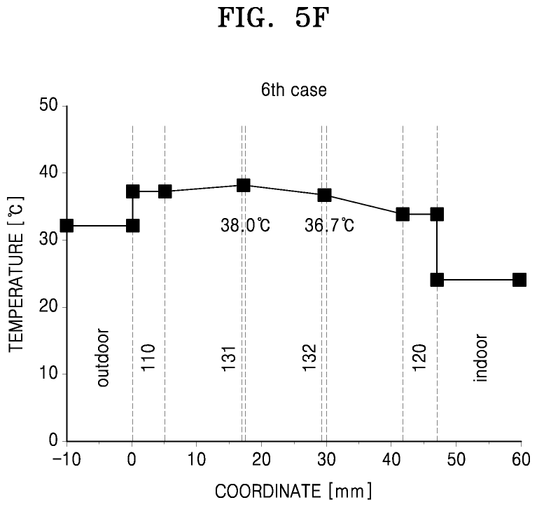

FIGS. 5A through 5F are graphs showing temperature profile simulation results of the first through sixth cases when insulating glazing units corresponding to the first through sixth cases are exposed to sunlight.

Referring to FIGS. 5A through 5F, the first case (first embodiment) provides an intermediate glass pane with a lower temperature than the second case (first comparative example) and the third case (second comparative example), and the fourth case (second embodiment) provides an intermediate glass pane with a lower temperature than the fifth case (third comparative example) and the sixth case (fourth comparative example). In other words, when the insulating glazing units according to embodiments of the present disclosure are exposed to sunlight, temperature increases of intermediate glass panes thereof are small, and accordingly, the possibility that thermal breakage of the intermediate glass panes occur may be low.

Table 5 shows simulation results of temperature differences between center locations (see 130C of FIG. 3) and edge locations (see 130E of FIG. 3) in the intermediate glass panes in the first through third cases and maximum principal stresses within the intermediate glass panes due to the temperature differences.

TABLE 5

| | Temperature | Maximum principal |
|---|---|---|
| | difference (° C.) | stress (MPa) |
| First case (first | 1.76 | 0.441 |
| embodiment) | | |
| Second case (first | 6.54 | 3.74 |
| comparative example) | | |
| Third case (second | 2.34 | 1.33 |
| comparative example) | | |

Referring to Table 5, a temperature difference and a maximum principal stress in the first case (first embodiment) are less than those in the second case (first comparative example) and those in the third case (second comparative example). Accordingly, the risk of thermal breakage in the first case (first embodiment) is less than that in the second case (first comparative example) and that in the third case (second comparative example). In other words, the insulating glazing units according to embodiments of the present disclosure may have a low risk of thermal breakage by employing, as an intermediate glass pane, a thin boro-aluminosilicate glass pane instead of a soda-lime glass pane.

The disclosed embodiments should be considered in descriptive sense only and not for purposes of limitation. The scope of the present disclosure is defined not by the detailed description of the present disclosure but by the appended claims, and all technical spirits within the scope will be construed as being included in the present disclosure.

An insulating glazing unit according to the present disclosure is lightweight, transparent, and has a low risk of thermal breakage due to a temperature difference.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

1. An insulating glazing unit comprising:
a first glass pane and a second glass pane apart from each other and arranged in parallel to each other;
an intermediate glass pane between the first glass pane and the second glass pane;
a first spacer between the first glass pane and the intermediate glass pane and separating the first glass pane from the intermediate glass pane;
a second spacer between the second glass pane and the intermediate glass pane and separating the second glass pane from the intermediate glass pane; and
a holder covering an edge portion of the first glass pane and an edge portion of the second glass pane and holding together the first glass pane, the second glass pane, the intermediate glass pane, the first spacer, and the second spacer,
wherein a thickness of the intermediate glass pane is less than a thickness of the first glass pane and a thickness of the second glass pane, and
wherein a composition of the intermediate glass pane is different from a composition of the first glass pane and a composition of the second glass pane.

2. The insulating glazing unit of claim 1, wherein the thickness of the intermediate glass pane is about 0.2 mm to about 1.0 mm.

3. The insulating glazing unit of claim 1, wherein a coefficient of thermal expansion of the intermediate glass pane is less than a coefficient of thermal expansion of the first glass pane and a coefficient of thermal expansion of the second glass pane.

4. The insulating glazing unit of claim 1, wherein the intermediate glass pane has not undergone a strengthening process.

5. The insulating glazing unit of claim 1, wherein solar absorptance of the intermediate glass pane is less than solar absorptance of the first glass pane and solar absorptance of the second glass pane.

6. The insulating glazing unit of claim 1, wherein solar transmittance of the intermediate glass pane is greater than solar transmittance of the first glass pane and solar transmittance of the second glass pane.

7. The insulating glazing unit of claim 1, wherein a density of the intermediate glass pane is less than a density of the first glass pane and a density of the second glass pane.

8. The insulating glazing unit of claim 1, wherein
each of the first glass pane and the second glass pane is formed of soda-lime glass, and
the intermediate glass pane is formed of boro-aluminosilicate glass.

9. An insulating glazing unit comprising:
a first soda-lime glass pane and a second soda-lime glass pane apart from each other and arranged in parallel to each other;
a boro-aluminosilicate glass pane between the first soda-lime glass pane and the second soda-lime glass pane;
a first spacer between the first soda-lime glass pane and the boro-aluminosilicate glass pane;
a second spacer between the second soda-lime glass pane and the boro-aluminosilicate glass pane; and
a holder covering an edge portion of the first soda-lime glass pane and an edge portion of the second soda-lime glass pane and holding together the first soda-lime glass pane, the second soda-lime glass pane, the boro-aluminosilicate glass pane, the first spacer, and the second spacer,
wherein a thickness of the boro-aluminosilicate glass pane is less than a thickness of the first soda-lime glass pane and a thickness of the second soda-lime glass pane.

10. An insulating glazing unit comprising:
a first glass plane and a second glass plane apart from each other and arranged in parallel to each other;
a plurality of intermediate glass panes disposed between the first glass pane and the second glass pane and spaced apart from each other;
a plurality of spacers respectively arranged between the first glass pane and one of the plurality of intermediate glass panes, between the second glass pane and another of the plurality of intermediate glass panes, and between the plurality of intermediate glass panes; and
a holder covering an edge portion of the first glass pane and an edge portion of the second glass pane and holding together the first glass pane, the second glass pane, the plurality of intermediate glass panes, and the plurality of spacers,
wherein a thickness of each of the plurality of intermediate glass panes is less than a thickness of the first glass pane and a thickness of the second glass pane, and
wherein a composition of each of the plurality of intermediate glass panes is different from a composition of the first glass pane and a composition of the second glass pane.

11. A building comprising the insulating glazing unit according to claim 1.

12. A refrigerator comprising the insulating glazing unit according to claim 1.

13. A freezer comprising the insulating glazing unit according to claim 1.

14. A building comprising the insulating glazing unit according to claim 9.

15. A refrigerator comprising the insulating glazing unit according to claim 9.

16. A freezer comprising the insulating glazing unit according to claim 9.

17. A building comprising the insulating glazing unit according to claim 10.

18. A refrigerator comprising the insulating glazing unit according claim 10.

19. A freezer comprising the insulating glazing unit according to claim 10.
